(19) United States
(12) Patent Application Publication
(10) Pub. No.: US 2018/0109814 A1
(43) Pub. Date: Apr. 19, 2018

(54) Method And Apparatus Of Coding Unit Information Inheritance

(71) Applicant: MediaTek Inc., Hsinchu City (TW)

(72) Inventors: Tzu-Der Chuang, Hsinchu City (TW); Ching-Yeh Chen, Hsinchu City (TW); Chih-Wei Hsu, Hsinchu City (TW)

(21) Appl. No.: 15/730,416

(22) Filed: Oct. 11, 2017

Related U.S. Application Data
(60) Provisional application No. 62/408,146, filed on Oct. 14, 2016.

(51) Int. Cl. H04N 19/96; H04N 19/66; H04N 19/44; H04N 19/645

(52) U.S. Cl. CPC H04N 19/96; H04N 19/645; H04N 19/44; H04N 19/66

(57) ABSTRACT

Concepts and examples pertaining to coding unit information inheritance are described. A processor of an encoder may receive media contents and encode the media contents to provide a bitstream of encoded media contents. A processor of a decoder may receive the bitstream of encoded media contents and decode the bitstream to provide one or more streams of decoded media contents. The bitstream may include information indicating coding unit (CU) information inheritance that is used by a decoder in conjunction with quad-tree (QT) partition and binary-tree (BT) partition to achieve asymmetric or triple-tree (TT) partition of a CU.

### CROSS REFERENCE TO RELATED PATENT APPLICATION(S)

The present disclosure claims the priority benefit of U.S. Provisional Patent Application No. 62/408,146, filed 14 Oct. 2016, the content of which is incorporated by reference in its entirety.

### TECHNICAL FIELD

The present disclosure is generally related to video processing and, more particularly, to coding unit information inheritance.

### BACKGROUND

Unless otherwise indicated herein, approaches described in this section are not prior art to the claims listed below and are not admitted as prior art by inclusion in this section.

In High Efficiency Video Coding (HEVC), adaptive coding unit (CU) partition is introduced. For instance, a large CU can be divided by quad-tree (QT) splitting, or partition, to divide the CU into four equal-sized sub-CU. In Joint Exploration Model (JEM) 3.0, a more flexible partition method, binary-tree (BT) splitting, or partition, is adopted to significantly improve coding efficiency. In some cases, for example, a large CU may be first divided by QT partition and then by BT partition.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to provide solutions, schemes, concepts, mechanisms, methods and systems pertaining to coding unit information inheritance with respect to BT partition for improved coding efficiency.

In one aspect, a method may involve a processor of an encoder receiving media contents. The method may also involve the processor encoding the media contents to provide a bitstream of encoded media contents. The bitstream may include information indicating CU information inheritance that is used by a decoder in conjunction with QT partition and BT partition to achieve asymmetric or triple-tree (TT) partition of a CU.

In one aspect, a method may involve a processor of a decoder receiving a bitstream of encoded media contents. The method may also involve the processor decoding the bitstream to provide one or more streams of decoded media contents. The bitstream may include information indicating CU information inheritance that is used by the processor in conjunction with QT partition and BT partition to achieve asymmetric or TT partition of a CU.

In one aspect, an apparatus may include an encoder. The encoder may include a processor capable of receiving media contents and encoding the media contents to provide a bitstream of encoded media contents. The bitstream may include information indicating CU information inheritance that is used by the processor in conjunction with QT partition and BT partition to achieve asymmetric or TT partition of a CU.

In one aspect, an apparatus may include a decoder. The decoder may include a processor capable of receiving a bitstream of encoded media contents and decoding the bitstream to provide one or more streams of decoded media contents. The bitstream may include information indicating CU information inheritance that is used by the processor in conjunction with QT partition and BT partition to achieve asymmetric or TT partition of a CU.

It is noteworthy that, although description provided herein may be in the context of HEVC, the proposed concepts, schemes and any variation(s)/derivative(s) thereof may be implemented in, for and by other types of video coding technologies, protocols, specifications and/or standards. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario of partitioning of a CU in accordance with an implementation of the present disclosure.

FIG. 2 is a diagram of an example scenario of merging of two different blocks in accordance with the present disclosure.

FIG. 3 is a diagram of an example apparatus in accordance with the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

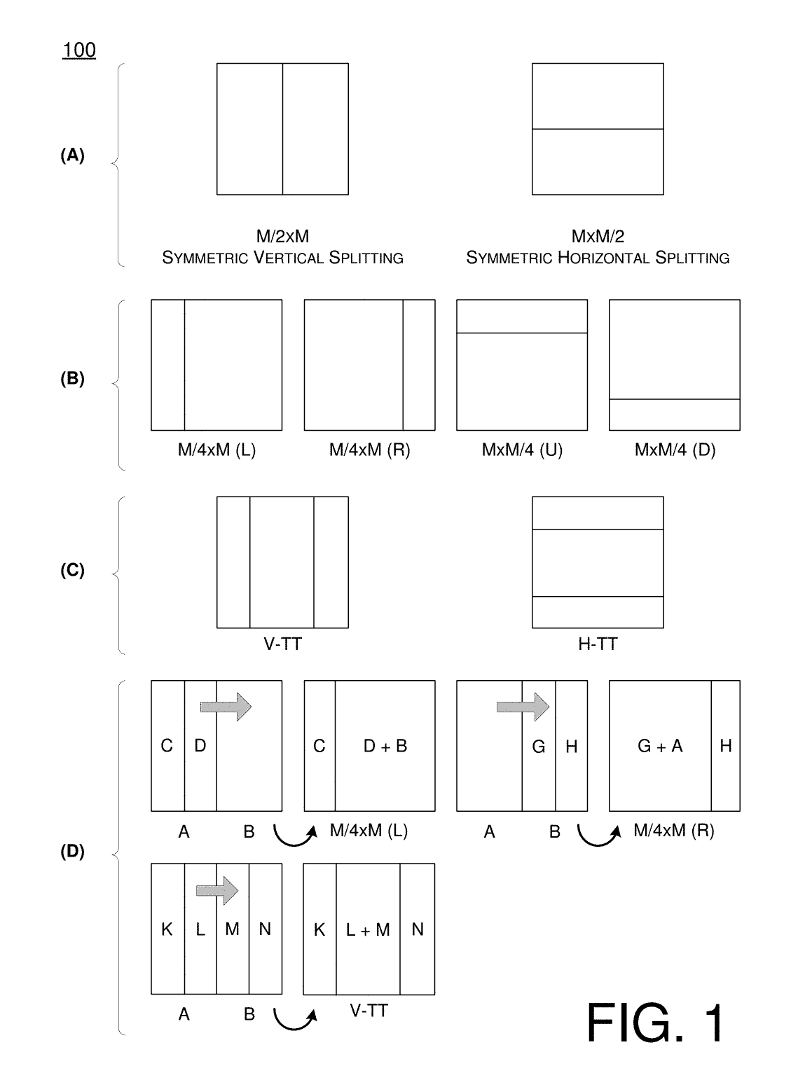

FIG. 1 illustrates an example scenario 100 of partitioning of a CU in accordance with an implementation of the present disclosure. In JEM-3.0, a binary tree (BT) can be split, or partitioned, into two symmetric partitions, either symmetric vertical partition or symmetric horizontal partition, as shown in part (A) of FIG. 1. In Joint Video Exploration Team (JVET), asymmetric partition and triple-tree (TT) partition to further improve coding efficiency has been proposed, as shown in parts (B) and (C) of FIG. 1, respectively. Referring to part (B) of FIG. 1, asymmetric partition of a CU may include the following: (1) asymmetric partition with a ¼ piece on the left side (denoted as “M/4×M (L)”), (2) asymmetric partition with a ¼ piece on the right side (denoted as “M/4×M (R)”), (3) asymmetric partition with a ¼ piece on the up side (denoted as “M×M/4 (U)”), and (4) asymmetric partition with a ¼ piece on the down side (denoted as “M×M/4 (D)”). Referring to part (C) of FIG. 1, TT partition may include vertical TT (denoted as “V-TT”) and horizontal TT (denoted as “H-TT”).

However, for asymmetric partition and/or TT partition, a quad tree (QT) would need to be partitioned into two BTs, with one of the two BTs further partitioned into two BTs. As shown in part (D) of FIG. 1, to achieve asymmetric partition using QT-BT partitions, a QT may be split, or partitioned, into two BTs, namely BT-A and BT-B. Moreover, BT-A may be further split, or partitioned, into two BTs, namely BT-C and BT-D. The combination of BT-C and BT-D plus BT-B would support the M/4×M (L) partition shown in part (B) of FIG. 1. Alternatively, to achieve asymmetric partition using QT-BT partitions, BT-B may be further split, or partitioned, into two BTs, namely BT-G and BT-H as shown in part (D) of FIG. 1. The combination of BT-H and BT-A plus BT-G would support the M/4×M (R) partition shown in part (B) of FIG. 1.

Taking the M/4×M (L) partition as an example, in an event that BT-B and BT-D share the same properties (e.g., the same motion vector (MV), affine parameter, intra mode and/or CU-level information), then several syntaxes may be required to merge or signal the information for BT-B. For example, in an event that BT-B and BT-D share the same MV, the merge mode and corresponding merge index may be signaled for BT-B. As another example, in an event that BT-B and BT-D share the same inter mode, the skip flag and/or merge flag as well as corresponding merge index may be signaled for BT-B. As yet another example, in an event that BT-B and BT-D share the same intra prediction mode, the most-probable-modes (MPM) flag (MPM_flag) and corresponding index (MPM_index) may be signaled for BT-B. However, as several syntax elements would be required to copy the CU information, there is still room for improvement in coding efficiency.

Under a proposed scheme in accordance with the present disclosure, CU information inheritance may be utilized to further improve coding efficiency. With respect to asymmetric partition and TT partition, the partition may be accomplished by BT plus CU information inheritance in accordance with the present disclosure. That is, the usage of BT with CU information inheritance may replace TT partition/asymmetric partition, with improved coding efficiency.

Referring to part (D) of FIG. 1, to achieve the asymmetric partition of M/4×M (L), a QT may be split, or partitioned, into two BTs, namely BT-A and BT-B. Moreover, BT-A may be further split, or partitioned, into two BTs, namely BT-C and BT-D. As BT-B and BT-D share the same properties in the resultant M/4×M (L), BT-B may inherit the properties of BT-D in accordance with the present disclosure, and a combined BT (denoted as “D+B” in part (D) of FIG. 1) may be formed. Thus, BT-C and the combined BT (of BT-D and BT-B) may support M/4×M (L).

As another example, to achieve the asymmetric partition of M/4×M (R), a QT may be split, or partitioned, into two BTs, namely BT-A and BT-B. Moreover, BT-B may be further split, or partitioned, into two BTs, namely BT-G and BT-H. As BT-G and BT-A share the same properties in the resultant M/4×M (R), BT-G may inherit the properties of BT-A in accordance with the present disclosure, and a combined BT (denoted as “G+A” in part (D) of FIG. 1) may be formed. Thus, BT-H and the combined BT (of BT-G and BT-A) may support M/4×M (R).

As a further example, to achieve the vertical TT partition (V-TT), a QT may be split, or partitioned, into two BTs, namely BT-A and BT-B. Moreover, each of BT-A and BT-B may be further split, or partitioned, into two respective BTs. That is, BT-A may be split, or partitioned, into BT-K and BT-L, and BT-B may be split, or partitioned, into BT-M and BT-N. As BT-L and BT-M share the same properties in the resultant V-TT, BT-M may inherit the properties of BT-L in accordance with the present disclosure, and a combined BT (denoted as “L+M” in part (D) of FIG. 1) may be formed. Thus, BT-K, BT-N and the combined BT (of BT-L and BT-M) may support V-TT.

Under the proposed scheme in accordance with the present disclosure, a CU-level CU_inherit_flag may be conditionally signaled to indicate whether a current block information should be inherited from (e.g., being copied from) the block information of one of the coded blocks (hereinafter interchangeably referred as the “reference coded block”). The reference coded block may be a last coded block, a neighboring block, or one of the coded blocks in a coded picture (e.g., temporally collocated blocks). In an event that CU_inherit_flag is true (e.g., the flag is set or the value thereof is set to 1), an inheritance list containing one or more coded blocks may be derived, and the reference coded block may be selected from the inheritance list. Alternatively, in lieu of selecting the reference coded block from an inheritance list, the reference coded block may be inferred without signaling (e.g., with CU_inherit_flag being true only). That is, the reference coded block may be predetermined or otherwise predefined (e.g., a neighboring block, the last coded block or a temporally collocated block) with respect to a current block for which CU information needs to be inherited from the reference coded block. In some implementations, the CU_inherit_flag may be signaled for determining whether or not to copy part or all of the CU information of the reference coded block. The copied CU information may include, for example and without limitation, prediction mode, intra mode, MV, frame rate up conversion (FRUC) mode, affine flag, generalized bi-prediction (GBi) index, intensity compensation (IC) flag, overlapped block motion compensation (OBMC) flag, explicit multiple core transform (EMT) flag and index, non-separable secondary transform (NSST) index, transform skip flag, cross component prediction (CCP) flag and index, and coding block flag.

Under the proposed scheme in accordance with the present disclosure, a CU_inherit_index may be signaled to indicate which block in the inheritance list may be the reference coded block, which is used for CU information inheritance. The inheritance list may include, for example and without limitation, a last coded block, previous N coded block(s), neighboring block(s), temporal collocated block(s), any other coded block(s), or a combination thereof. Alternatively, the CU_inherit_index may be inferred and not signaled. For instance, in an event that CU_inherit_flag is true (e.g., the flag is set or the value thereof is set to 1), the CU information of a predefined or derived block (e.g., the last coded block), which is the inferred reference coded bloc, may be copied to a current block.

In an event that the CU_inherit_flag is true (e.g., the flag is set or the value thereof is set to 1), the CU information of a current block may be inherited from the reference coded block, which may be one of the coded blocks. The CU information may include, for example and without limitation, skip flag, MV, reference picture index, interDir, merge flag, merge index, luma intra mode, chroma intra mode, QP, cbf, affine parameter, ic_flag, line-index of multi-line intra prediction, pattern-matched motion vector derivation (PMVD) flag, PMVD mode, doubling-increase/multiplicative-decrease (DIMD) flag, DIMD mode, DIMD derived mode, palette mode, palette table, any CU-level syntax, any prediction unit (PU)-level syntax, or any combination of the above information. For example, in some implementations, in an event that the CU_inherit_flag is true (e.g., the flag is set or the value thereof is set to 1), the CU information of the last coded block, as the reference coded block, may be copied to the current block. If the last coded block is a normal inter coded block, the MVs of the last coded block may be copied to the current block. If the last coded block is an affine inter coded block, the affine parameter(s) may be inherited. The MVs may be generated by the inherited affine parameter(s). If the last coded block is an advanced temporal motion vector prediction (TMVP) block, the current block may be also the advanced TMVP block. If the last coded block is a skip block, the current may be also the skip block with the same motion model. If the last coded block is an intra coded block, the luma intra mode and chroma intra mode of the current block may be inherited from the last coded block. The residual coefficients may not be inherited. The transform unit (TU) information of the current block may need to be signaled. In other words, in an event that the CU_inherit_flag is true (e.g., the flag is set or the value thereof is set to 1), a current block and the last coded block may be treated as one block but with independent TUs.

Under the proposed scheme in accordance with the present disclosure, utilization of CU information inheritance may provide a result similar to merging two different blocks into one block. Thus, flexible partitioning may be supported. Under the proposed scheme, which block is merged from may depend on the coding order and block partition. For example, the CU information may be inherited or otherwise copied from the last coded block. As another example, the CU information may be inherited or otherwise copied from a neighboring block that is to the left or above the current block. The selection between the neighboring block that is to the left of the current block and the neighboring block that is above the current block may be according to block partition order. In some implementations, in an event that it is the motion information and no other part of the CU information that is to be inherited from a neighboring block, the procedure may be similar to that of merge mode but signaling of the merge index may not be necessary.

In some implementations, a CU merge flag (e.g., CU_merge_flag) may be conditionally signaled for a leaf CU. For instance, if the CU_merge_flag is true (e.g., the flag is set or the value thereof is set to 1), a current block may be merged to a previously coded block (e.g., the last coded block) to form a larger block. In some implementations, each block of the two blocks that merge to form a new block may still retain its corresponding TU. In such cases, the TUs are separated and not merged. Alternatively, the TUs corresponding to the two blocks being merged together may also be merged together to form a larger TU.

Under the proposed scheme, CU information inheritance may be conditional. Under one condition of the proposed scheme, the CU_inherit_flag may be signaled (e.g., the flag is set or the value thereof is set to 1) for BT leaf CU but not for other types of blocks. That is, the CU_inherit_flag may be inferred as 0 (e.g., the flag is not set) for QT leaf CU. Under another condition of the proposed scheme, the CU_inherit_flag may be signaled (e.g., the flag is set or the value thereof is set to 1) when the shaped of the new block, as a result of merge of a current block and a last coded block, would still be a rectangle. Under yet another condition of the proposed scheme, the CU_inherit_flag may not be signaled (e.g., the flag is not set) when the new block, as a result of a merge of two BTs, would be the same as or otherwise equal to a parent block from which the two BTs are derived. Under still another condition of the proposed scheme, the CU_inherit_flag may not be signaled (e.g., the flag is not set) when the last coded block is in another QT. In signaling the CU_inherit_flag, the aforementioned conditions may be applied together or, alternatively, any combination of the aforementioned conditions may be applied. Moreover, the aforementioned conditions or any combination thereof may be used when generating the CU inheritance list.

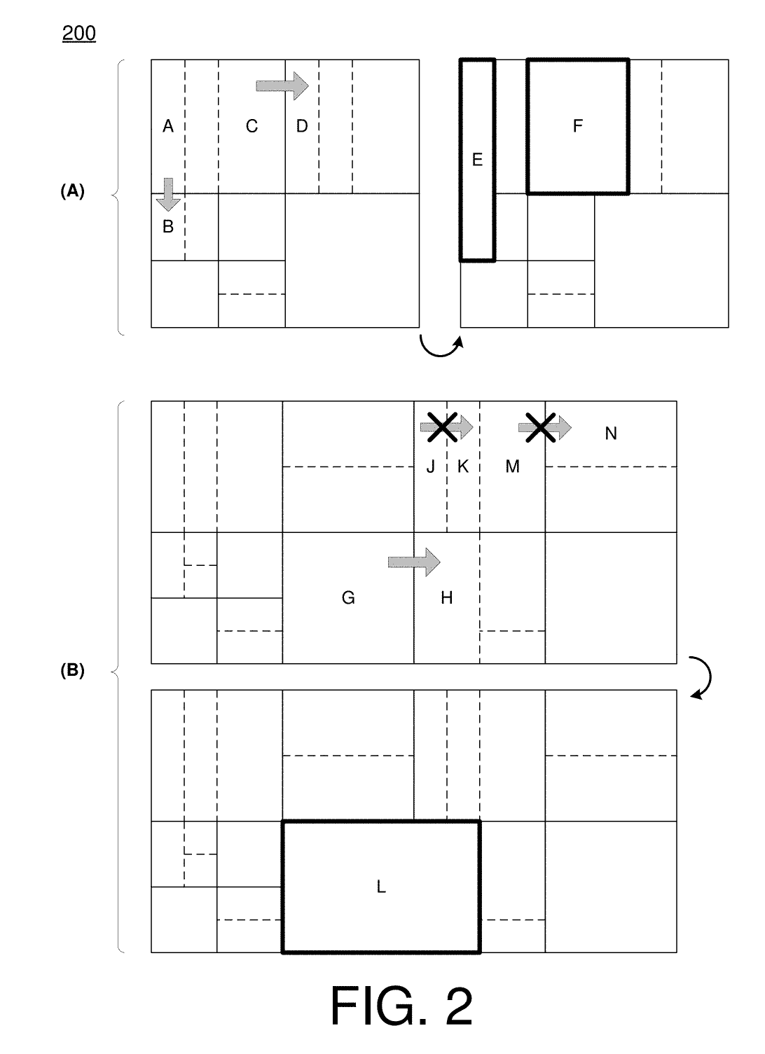

FIG. 2 illustrates an example scenario 200 of merging of two different blocks in accordance with an implementation of the present disclosure. Referring to part (A) of FIG. 2, the CU information of a block from a different coded tree unit (CTU) may be inherited or otherwise copied by a current block. For instance, BT-A and BT-B, each from a different CTU, may be merged to form a new block (denoted as “BT-E”). The new block BT-E may be formed by BT-B inheriting the CU information of BT-A. Alternatively, the new block BT-E may be formed by BT-A inheriting the CU information of BT-B. Similarly, BT-C and BT-D, each from a different CTU, may be merged to form a new block (denoted as “BT-F”). The new block BT-F may be formed by BT-C inheriting the CU information of BT-D. Alternatively, the new block BT-F may be formed by BT-D inheriting the CU information of BT-C.

Referring to part (B) of FIG. 2, the CU information of a block that does not belong to the same rectangle of a current block may be inherited or otherwise copied. For instance, BT-G and BT-H, each from a different rectangle, may be merged to form a new block (denoted as “BT-L”). The new block BT-L may be formed by BT-G inheriting the CU information of BT-H. Alternatively, the new block BT-L may be formed by BT-H inheriting the CU information of BT-G.

However, as shown in part (B) of FIG. 2, under the proposed scheme, a new block may not be formed by merging BT-M and BT-N, each of which being from a different rectangle. This is because, as described above, one of the conditions under the proposed scheme may prohibit the merge of two BTs to form a new block if the new block would not be a rectangle. In the example shown in part (B) of FIG. 2, if BT-M and BT-N were to be merged, the new block thus formed would have be an L-shaped BT but not rectangular. Thus, the merge of BT-M and BT-N may be prohibited under the proposed scheme.

Moreover, as shown in part (B) of FIG. 2, one of the conditions under the proposed scheme may prohibit the merge of two BTs to form a new block if the new block would be the same as a parent block from which the two BTs are derived. In the example shown in part (B) of FIG. 2, if BT-J and BT-K were to be merged, the new block thus formed would be the same as the parent block from which BT-J and BT-K are derived. Thus, the merge of BT-J and BT-K may be prohibited under the proposed scheme.

Under the proposed scheme, with respect to temporally collocated blocks, a sub-block motion mode in accordance with the present disclosure may be applicable. For instance, referring to part (A) of FIG. 2, block BT-F may be a temporally collocated block of blocks BT-C and BT-D. That is, with blocks BT-C and BT-D being in a first frame, block BT-F may be collocated with respect to BT-C and BT-D but in a second frame which is temporally subsequent to the first frame. In such cases, the left portion of BT-F may share one or more properties with BT-C and the right portion of BT-F may share one or more properties with BT-D. For example, motion vector(s) for the left portion of BT-F may be copied from BT-C, and motion vector(s) for the right portion of BT-F may be copied from BT-D. Thus, even though BT-F may be a complete CU by itself, pixels corresponding to different portions BT-F may be displayed using parameters copied from temporally collocated blocks (e.g., BT-C and BT-D).

### Illustrative Implementation

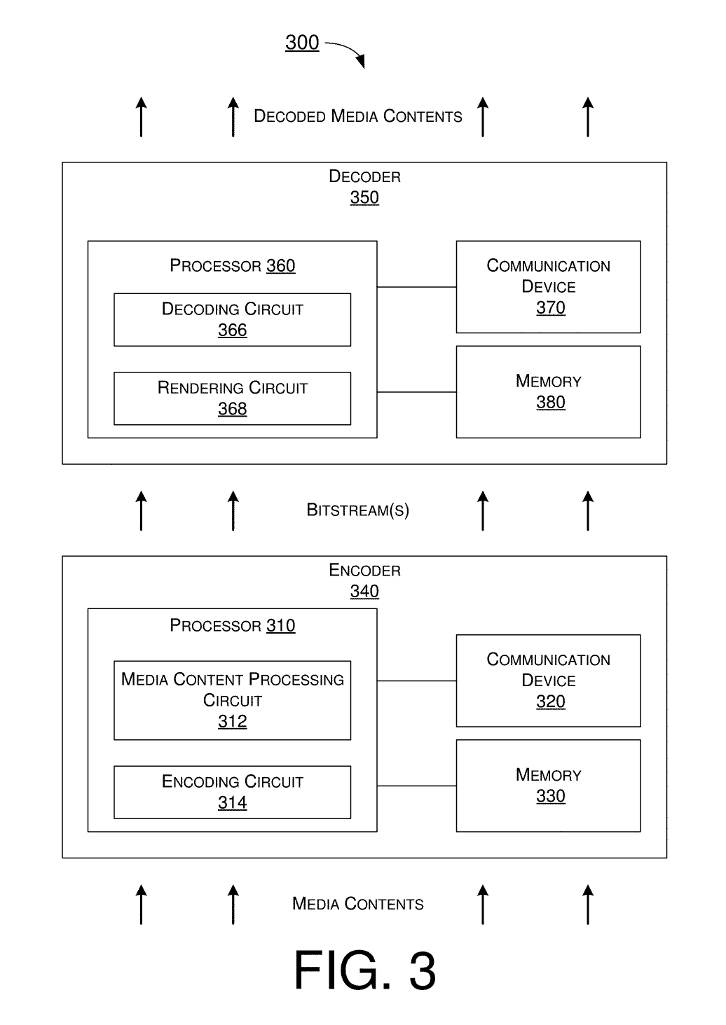

FIG. 3 illustrates an example apparatus 300 in accordance with an implementation of the present disclosure. Apparatus 300 may perform various functions to implement schemes, techniques, processes and methods described herein pertaining to coding unit information inheritance, including the various schemes, concepts and examples described above with respect to scenarios 100 and 200 described above as well as processes 400 and 500 described below.

Apparatus 300 may be a part of an electronic apparatus, which may be a portable or mobile apparatus, a wearable apparatus, a wireless communication apparatus or a computing apparatus. For instance, apparatus 300 may be implemented in a smartphone, a smartwatch, a personal digital assistant, a digital camera, or a computing equipment such as a tablet computer, a laptop computer or a notebook computer. Apparatus 300 may also be a part of a machine type apparatus, which may be an Internet-of-Things (IoT) apparatus such as an immobile or a stationary apparatus, a home apparatus, a wire communication apparatus or a computing apparatus.

In some implementations, apparatus 300 may be implemented in the form of one or more integrated-circuit (IC) chips such as, for example and without limitation, one or more single-core processors, one or more multi-core processors, or one or more complex-instruction-set-computing (CISC) processors. Apparatus 300 may include at least some of those components shown in FIG. 3 such as an encoder 340 having a processor 310 and/or a decoder 350 having a processor 360, for example. Apparatus 300 may further include one or more other components not pertinent to the proposed scheme of the present disclosure (e.g., internal power supply, display device and/or user interface device), and, thus, such component(s) of apparatus 300 are neither shown in FIG. 3 nor described below in the interest of simplicity and brevity.

In one aspect, each of processor 310 and processor 360 may be implemented in the form of one or more single-core processors, one or more multi-core processors, or one or more CISC processors. That is, even though a singular term “a processor” is used herein to refer to each of processor 310 and processor 360, each of processor 310 and processor 360 may include multiple processors in some implementations and a single processor in other implementations in accordance with the present disclosure. In another aspect, each of processor 310 and processor 360 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 310 and processor 360 is a special-purpose machine specifically designed, arranged and configured to perform specific tasks including those pertaining to coding unit information inheritance in accordance with various implementations of the present disclosure. Processor 310 may include a media content processing circuit 312 and an encoding circuit 314. Processor 360 may include a decoding circuit 366 and a rendering circuit 368.

In some implementations, apparatus 300 may also include a communication device 320 coupled to processor 310 as well as a communication device 370 coupled to processor 360. Each of communication device 320 and communication device 370 may include a transceiver that is capable of transmitting and receiving data, information and/or signals wirelessly and/or via wired medium(s). In some implementations, apparatus 300 may further include a memory 330 coupled to processor 310 as well as a memory 380 coupled to processor 360, each being capable of being accessed by processor 310 or processor 360, respectively, and storing data therein. Each of memory 330 and memory 380 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 330 and memory 380 may include a type of read-only memory (ROM) such as mask ROM, programmable ROM (PROM), erasable programmable ROM (EPROM) and/or electrically erasable programmable ROM (EEPROM). Alternatively or additionally, each of memory 330 and memory 380 may include a type of non-volatile random-access memory (NVRAM) such as flash memory, solid-state memory, ferroelectric RAM (FeRAM), magnetoresistive RAM (MRAM) and/or phase-change memory.

In some implementations, media content processing circuit 312 may be capable of receiving (e.g., via communication device 320) media contents. Media content processing circuit 312 may also be capable of processing the media contents. Encoding circuit 314 may be capable of encoding the processed media contents to provide at least one bitstream. The bitstream may include information indicating CU information inheritance that is used by a decoder (e.g., decoder 350) in conjunction with QT partition and BT partition to achieve asymmetric or TT partition of a CU.

In some implementations, decoding circuit 366 may be capable of decoding encoded media contents. For instance, decoding circuit 366 may be capable of decoding at least one bitstream containing encoded media contents to provide one or more streams of decoded media contents. Rendering circuit 368 may be capable of rendering the decoded media contents for display (by apparatus 300 or a remote apparatus or device). For instance, rendering circuit 368 may be capable of rendering one or more viewports, one or more regions, or a combination thereof based on video contents in the one or more streams of decoded media contents.

In some implementations, the bitstream may include one or more flags set to signal the decoder to perform a number of operations. For instance, the one or more flags may signal the decoder to bisect a parent CU into two blocks. Moreover, the one or more flags may signal the decoder to copy at least a portion of CU information of a reference coded block for coding of one of the two blocks to form a merged CU as a combination of the one of the two blocks and the reference coded block.

In the interest of brevity and to avoid redundancy, further detailed description of functions, capabilities and operations of apparatus 300 is provided below with respect to processes 400 and 500.

### Illustrative Processes

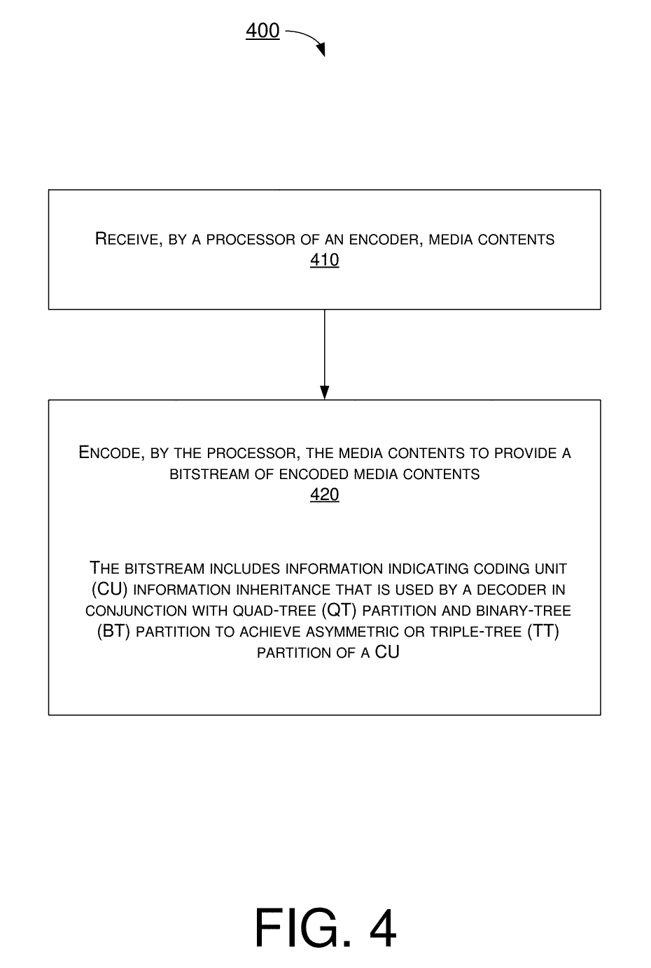

FIG. 4 illustrates an example process 400 in accordance with an implementation of the present disclosure. Process 400 may represent an aspect of implementing the proposed concepts and schemes such as one or more of the various solutions, schemes, concepts and examples described above with respect to FIG. 1˜FIG. 3. More specifically, process 400 may represent an aspect of the proposed concepts and schemes pertaining to coding unit information inheritance. For instance, process 400 may be an example implementation, whether partially or completely, of the proposed schemes, concepts and examples described above for coding unit information inheritance. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively in a different order. The blocks/sub-blocks of process 400 may be executed iteratively. Process 400 may be implemented by or in apparatus 300 as well as any variations thereof. Solely for illustrative purposes and without limiting the scope, process 400 is described below in the context of encoder 340. Process 400 may begin at block 410.

At 410, process 400 may involve processor 310 of encoder 340 receiving media contents. Process 400 may proceed from 410 to 420.

At 420, process 400 may involve processor 310 encoding the media contents to provide a bitstream of encoded media contents. The bitstream may include information indicating CU information inheritance that is used by a decoder in conjunction with QT partition and BT partition to achieve asymmetric or TT partition of a CU.

In some implementations, the bitstream may include one or more flags set to signal the decoder to perform a number of operations. For instance, the one or more flags may signal the decoder to bisect a parent CU into two blocks. Moreover, the one or more flags may signal the decoder to copy at least a portion of CU information of a reference coded block for coding of one of the two blocks to form a merged CU as a combination of the one of the two blocks and the reference coded block.

In some implementations, the reference coded block may be inferred or predefined with respect to the one of the two blocks. In some implementations, the reference coded block may be a neighboring block, a last coded block, or a temporally collocated block.

In some implementations, the bitstream may also include an inheritance index based on which the decoder constructs an inheritance list that lists a number of coded blocks each being a candidate to be the reference coded block. Moreover, the copying of at least a portion of CU information of the reference coded block for coding of one of the two blocks may involve selecting the reference coded block from the inheritance list. In some implementations, the inheritance list may contain a last coded block, one or more previous coded blocks, one or more neighboring blocks, one or more temporal collocated blocks, one or more other coded blocks, or a combination thereof.

In some implementations, the parent CU may be from a first CTU, and the reference coded block may be from a second CTU different from the first CTU.

In some implementations, the merged CU may be different from the parent CU.

In some implementations, the merged CU may be rectangular in shape.

In some implementations, the merged CU may be associated with a merged transform unit (TU) which is a combination of a first TU associated with the one of the two blocks and a second TU associated with the reference coded block.

In some implementations, each of the two blocks may be a BT leaf CU.

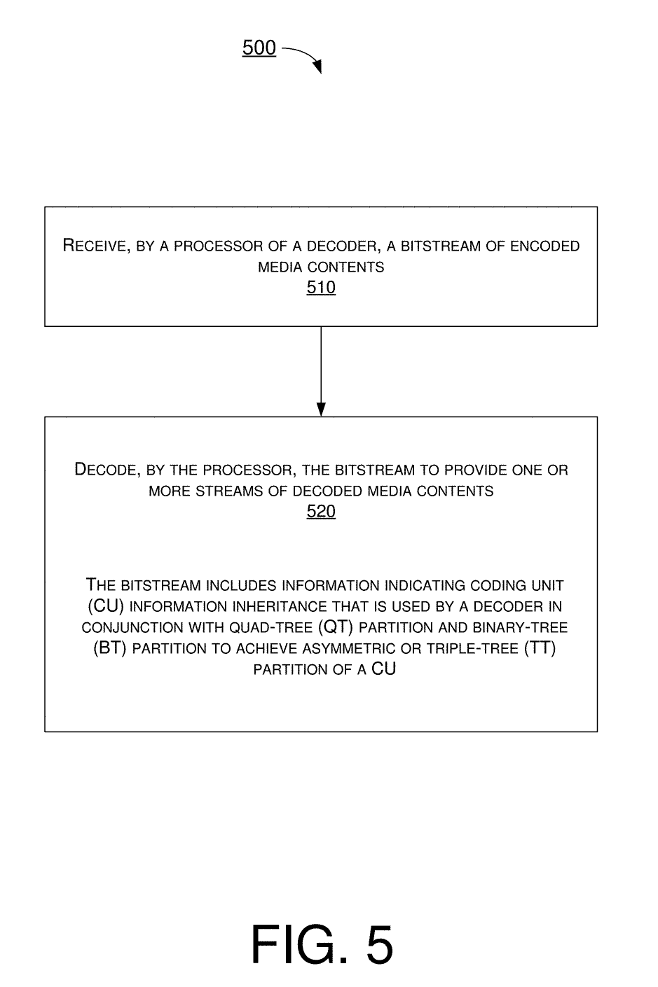

FIG. 5 illustrates an example process 500 in accordance with an implementation of the present disclosure. Process 500 may represent an aspect of implementing the proposed concepts and schemes such as one or more of the various solutions, schemes, concepts and examples described above with respect to FIG. 1˜FIG. 3. More specifically, process 500 may represent an aspect of the proposed concepts and schemes pertaining to coding unit information inheritance. For instance, process 500 may be an example implementation, whether partially or completely, of the proposed schemes, concepts and examples described above for coding unit information inheritance. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively in a different order. The blocks/sub-blocks of process 500 may be executed iteratively. Process 500 may be implemented by or in apparatus 300 as well as any variations thereof. Solely for illustrative purposes and without limiting the scope, process 500 is described below in the context of decoder 350. Process 500 may begin at block 510.

At 510, process 500 may involve processor 360 of decoder 350 receiving a bitstream of encoded media contents. Process 500 may proceed from 510 to 520.

At 520, process 500 may involve processor 360 decoding the bitstream to provide one or more streams of decoded media contents. The bitstream may include information indicating CU information inheritance that is used by a decoder in conjunction with QT partition and BT partition to achieve asymmetric or TT partition of a CU.

In some implementations, the bitstream may include one or more flags set to signal the decoder to perform a number of operations. For instance, the one or more flags may signal the decoder to bisect a parent CU into two blocks. Moreover, the one or more flags may signal the decoder to copy at least a portion of CU information of a reference coded block for coding of one of the two blocks to form a merged CU as a combination of the one of the two blocks and the reference coded block.

In some implementations, the reference coded block may be inferred or predefined with respect to the one of the two blocks. In some implementations, the reference coded block may be a neighboring block, a last coded block, or a temporally collocated block.

In some implementations, the bitstream may also include an inheritance index based on which the decoder constructs an inheritance list that lists a number of coded blocks each being a candidate to be the reference coded block. Moreover, the copying of at least a portion of CU information of the reference coded block for coding of one of the two blocks may involve selecting the reference coded block from the inheritance list. In some implementations, the inheritance list may contain a last coded block, one or more previous coded blocks, one or more neighboring blocks, one or more temporal collocated blocks, one or more other coded blocks, or a combination thereof.

In some implementations, the parent CU may be from a first CTU, and the reference coded block may be from a second CTU different from the first CTU.

In some implementations, the merged CU may be different from the parent CU.

In some implementations, the merged CU may be rectangular in shape.

In some implementations, the merged CU may be associated with a merged TU which is a combination of a first TU associated with the one of the two blocks and a second TU associated with the reference coded block.

In some implementations, each of the two blocks may be a BT leaf CU.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an encoder, media contents; and
encoding, by the processor, the media contents to provide a bitstream of encoded media contents,
wherein the bitstream comprises information indicating coding unit (CU) information inheritance that is used by a decoder in conjunction with quad-tree (QT) partition and binary-tree (BT) partition.

2. The method of claim 1, wherein the bitstream comprises one or more flags set to signal the decoder to perform operations comprising:
bisecting a parent CU into two blocks; and
copying at least a portion of CU information of a reference coded block for coding of one of the two blocks to form a merged CU as a combination of the one of the two blocks and the reference coded block.

3. The method of claim 2, wherein the reference coded block is predefined with respect to the one of the two blocks.

4. The method of claim 3, wherein the reference coded block comprises a neighboring block, a last coded block, or a temporally collocated block.

5. The method of claim 2, wherein the bitstream further comprises an inheritance index based on which the decoder constructs an inheritance list that lists a number of coded blocks each being a candidate to be the reference coded block, and wherein the copying of at least a portion of CU information of the reference coded block for coding of one of the two blocks comprises selecting the reference coded block from the inheritance list.

6. The method of claim 5, wherein the inheritance list contains a last coded block, one or more previous coded blocks, one or more neighboring blocks, one or more temporal collocated blocks, one or more other coded blocks, or a combination thereof.

7. The method of claim 2, wherein the parent CU is from a first coded tree unit (CTU), and wherein the reference coded block is from a second CTU different from the first CTU.

8. The method of claim 2, wherein the merged CU is different from the parent CU, and wherein the merged CU is rectangular in shape.

9. The method of claim 2, wherein the merged CU is associated with a merged transform unit (TU) which is a combination of a first TU associated with the one of the two blocks and a second TU associated with the reference coded block.

10. The method of claim 2, wherein each of the two blocks comprises a BT leaf CU.

11. A method, comprising:
receiving, by a processor of a decoder, a bitstream of encoded media contents; and
decoding, by the processor, the bitstream to provide one or more streams of decoded media contents,
wherein the bitstream comprises information indicating coding unit (CU) information inheritance that is used by the processor in conjunction with quad-tree (QT) partition and binary-tree (BT) partition.

12. The method of claim 11, wherein the bitstream comprises one or more flags set to signal the processor to perform operations comprising:
bisecting a parent CU into two blocks; and
copying at least a portion of CU information of a reference coded block for coding of one of the two blocks to form a merged CU as a combination of the one of the two blocks and the reference coded block.

13. The method of claim 12, wherein the reference coded block is predefined with respect to the one of the two blocks.

14. The method of claim 13, wherein the reference coded block comprises a neighboring block, a last coded block, or a temporally collocated block.

15. The method of claim 12, wherein the bitstream further comprises an inheritance index based on which the decoder constructs an inheritance list that lists a number of coded blocks each being a candidate to be the reference coded block, and wherein the copying of at least a portion of CU information of the reference coded block for coding of one of the two blocks comprises selecting the reference coded block from the inheritance list.

16. The method of claim 15, wherein the inheritance list contains a last coded block, one or more previous coded blocks, one or more neighboring blocks, one or more temporal collocated blocks, one or more other coded blocks, or a combination thereof.

17. The method of claim 12, wherein the parent CU is from a first coded tree unit (CTU), and wherein the reference coded block is from a second CTU different from the first CTU.

18. The method of claim 12, wherein the merged CU is different from the parent CU, and wherein the merged CU is rectangular in shape.

19. The method of claim 12, wherein the merged CU is associated with a merged transform unit (TU) which is a combination of a first TU associated with the one of the two blocks and a second TU associated with the reference coded block.

20. The method of claim 12, wherein each of the two blocks comprises a BT leaf CU.

21. An apparatus, comprising:
an encoder comprising a processor capable of performing operations comprising:
receiving media contents; and
encoding the media contents to provide a bitstream of encoded media contents,
wherein the bitstream comprises information indicating coding unit (CU) information inheritance that is used by a decoder in conjunction with quad-tree (QT) partition and binary-tree (BT) partition.

22. The apparatus of claim 22, wherein the bitstream comprises one or more flags set to signal the decoder to perform operations comprising:
bisecting a parent CU into two blocks; and
copying at least a portion of CU information of a reference coded block for coding of one of the two blocks to form a merged CU as a combination of the one of the two blocks and the reference coded block.

23. An apparatus, comprising:
a decoder comprising a processor capable of performing operations comprising:
receiving a bitstream of encoded media contents; and
decoding the bitstream to provide one or more streams of decoded media contents,
wherein the bitstream comprises information indicating coding unit (CU) information inheritance that is used by the processor in conjunction with quad-tree (QT) partition and binary-tree (BT) partition.

24. The apparatus of claim 23, wherein the bitstream comprises one or more flags set to signal the processor to perform operations comprising:
bisecting a parent CU into two blocks; and
copying at least a portion of CU information of a reference coded block for coding of one of the two blocks to form a merged CU as a combination of the one of the two blocks and the reference coded block.
